(19) United States
(12) Patent Application Publication
(10) Pub. No.: US 2005/0095522 A1
(43) Pub. Date: May 5, 2005

(54) Control of charge-to-mass of toner using silica blends

(75) Inventors: William K. Goebel, Springwater, NY (US); Matthew C. Ezenyilimba, Walworth, NY (US); Donald S. Rimai, Webster, NY (US); James H. Anderson, Rochester, NY (US)

Correspondence Address: Lawrence P. Kessler;Eastman Kodak Company, Patent Legal Staff, 343 State Street, Rochester, NY, 14650-2201, US

(73) Assignee: Eastman Kodak Company

(21) Appl. No.: 10/973,043

(22) Filed: Oct. 25, 2004

Related U.S. Application Data
(60) Provisional application No. 60/515,624, filed on Oct. 30, 2003.

(51) Int. Cl. G03G 9/08

(52) U.S. Cl. 430/108.7; 430/137.1

(57) ABSTRACT

Controlling the charge-to-mass of the particulate toner in a two-component developer by surface treating the toner particles with a blend of two or more types of silica particles that differ in the functional group appended to the silica particles.

### FIELD OF THE INVENTION

This invention relates to electrophotographic two-component developers and more specifically to control of the charge-to-mass of the toner in such developers.

### BACKGROUND OF THE INVENTION

In electrophotographic reproduction apparatus and printers, an electrostatic latent image is formed on a photoconducting imaging member by first uniformly charging the imaging member and then image-wise exposing the imaging member using various devices such as a scanned laser, LED array, optical flash, or other suitable, known methods. The electrostatic latent image is then developed into a visible image by bringing the imaging member into close proximity with a developer that includes toner particles. In a 2-component developer, toner particles are mixed with larger, magnetic particles called carrier particles. The toner particles become triboelectrically charged by contact with the carrier particles. The developer is contained in a development station that typically includes a roller with a magnetic core, a sump that contains a quantity of developer, a device for determining the concentration of toner in the developer, and a mechanism for replenishing the toner when the toner concentration drops below a certain level. The carrier particles transport the toner into contact with the imaging member bearing the electrostatic latent image. The development station is suitably biased and the toner particles suitably charged so that the proper amount of toner particles is deposited in either the charged or discharged regions of the imaging member.

After the electrostatic latent image on the imaging member has been developed, the toned image is generally transferred to a receiver such as paper or transparency stock. This is generally accomplished by applying an electric field in such a manner to urge the toner from the imaging member to the receiver. In some instances, it is preferable to first transfer the toned image from the imaging member to an intermediate member and then from the intermediate member to the receiver. Again, this is most commonly accomplished by applying an electric field to urge the toned image towards the appropriate member.

The electrophotographic imaging process described above may be used to produce mono-color, typically black, or multi-color images. In so-called full-color or process-color imaging, toner pigmented with the subtractive primary colors, cyan, magenta, and yellow, are used along with black toner. Cyan, magenta, yellow, and black developed toner images are created separately by the above-described process and transferred in register to the receiver. This process is typically used for pictorial imaging. A range or gamut of colors is produced by the varying amounts of the subtractive primary colored toners plus black in the image. Alternatively, it is sometimes desirable to employ a spot color or custom color toner in a single developer station to create a single colored image. Corporate logos and the like are such applications. Custom color toner may be produced by incorporating a custom color pigment into the toner during the toner manufacturing process. An alternative method of producing a custom color toner is to create the custom color toner by blending together appropriate amounts of component toners pigmented during manufacture with the subtractive primary colored pigments, cyan, magenta, and yellow. If the desired custom color is not within the gamut of the cyan, magenta, and yellow component toners, additional colored component toners may be used in the blended custom color toner. This method is analogous to the mixing of component color paints to produce custom color paint.

The rate at which toner is developed, from the development station, onto the electrostatic latent image is dependent on several parameters, including the toner charge, specifically the toner charge normalized to the mass of the toner particle and designated as charge-to-mass (q/m). As described above, the toner is charged by triboelectric interaction with the magnetic carrier particles. The toner charge is determined, in part, by the choice of charge agents incorporated into the toner during manufacture. However, toner q/m may also depend on other post manufacturing parameters. For example, toner q/m will vary with the toner particle size. Since the toner is charged through a triboelectric process, the more surface area available, the higher the value of q/m can be. Since smaller particles have higher surface area for a given mass than larger particles, q/m tends to increase as the size of the toner decreases. Different pigments used in color toners may also have different triboelectric properties. This results in different color toners potentially having different q/m ratios if mixed with the same carrier to form a developer. If the q/m of the component toners blended to make a custom color toner are significantly different, the components of the blended toner will develop the electrostatic latent image at different rates, thereby causing the color of the blended toner to vary with use.

In applications of electrophotographic imaging, such as digital color printing, where the highest image quality is desired, it is preferred to use the smallest particle size of toner as is feasible. The smaller the toner particle size, the sharper and less grainy will be the toned image. Many aspects of the electrophotographic imaging process become more challenging as the toner particle size becomes smaller. One of the challenging aspects of using smaller and smaller sized toner particles is the dependence, described above, of the toner q/m on particle size. Toner manufacturing processes are typically batch processes and some variability in toner particle size, and therefore q/m, typically occurs from batch to batch. Toner q/m varies as surface area of the toner particle and therefore as the square of toner particle diameter. So, for example, a toner particle size change of 1.0 μm for an 8.0 μm toner particle will result in a 27% change in q/m, whereas a 1.0 μm change for a 4.0 μm toner particle will result in a 56% change in q/m. Therefore, as smaller and smaller toner particle sizes are sought for higher and higher image quality, batch to batch toner size variations can produce significant variations of toner q/m. These batch to batch q/m variations can cause unacceptable batch to batch image quality variations.

### SUMMARY OF THE INVENTION

In view of the above, it is the object of the present invention to provide a post toner production method of adjusting the triboelectric properties of the toner to be used in a two-component electrophotographic developer. It has been discovered that small particulate silica addenda, typically applied to the surface of the toner to improve toner flow and transferability, may also be used to adjust the triboelectric properties of the toner. Specifically, combinations of two or more types of silica particles, differing in the functionality of groups appended to the surface of the silica particles, may be used to adjust q/m of the toner in 2-component electrophotographic developers. Accordingly, toner can be surface treated with predetermined blends of two or more of these silica particulate addenda so that, when mixed with carrier particles to produce a developer, the toner will tribocharge to the same q/m, independent of such variables as batch-to-batch particle size variations, different pigments in different color toners, or any other property upon which the bare toner triboelectric properties might depend.

The invention, and its objects and advantages, will become more apparent in the detailed description of the preferred embodiment presented below.

### BRIEF DESCRIPTION OF THE DRAWINGS

The invention and its technical advantages will be better appreciated from the ensuing detailed description of a preferred embodiment, reference being made to the accompanying drawing where:

The FIGURE is a plot of the charge-to-mass ratio of example toner samples, prepared by the method of this invention, versus the percent of one of the two silicas used to prepare the various toner samples.

### DETAILED DESCRIPTION OF THE INVENTION

Toners for two component developers for use in electrophotographic imaging processes are typically made either by mechanical pulverization methods or by chemical methods such as limited coalescence, evaporative limited coalescence, emulsion polymerization, suspension polymerization, or other known chemical methods. Typically none of these methods produce perfectly mono-disperse sized toner particles, but rather toner particle size distributions. For the purpose of this disclosure the following definitions with respect to toner particle size distributions, as measured, for example with a Coulter Multisizer, are used:

Number Median, DN(50)—In the number distribution, the particle size at which half of the particles are larger and half are smaller.

Volume Median, DV(50)—In the volume distribution, the particle size at which half of the particles are larger and half are smaller.

Fineness Index—In the number distribution, the ratio of the Number Median to the particle size at which the sum of 16% of the particles, DN(16), on the fine side of the distribution, is reached.

Volume weighted average diameter—In the volume distribution, the average diameter of a spherical particle calculated by weighting the diameter of each particle by the volume of a sphere of equal mass and density and dividing by the total volume of the particles.

Number weighted average diameter—In the number distribution, the average diameter of a spherical particle calculated by weighting the diameter of each particle by the number of particles having that diameter and dividing by the total number of the particles.

Except where otherwise noted, the term “toner diameter” refers to the volume weighted average diameter.

The addition of small particulate addenda to the surface of toner particles to improve flow and transferability is well known. In addition, the use of several different types of particulate addenda such as silica and titanium dioxide is also well known. However, it has been discovered that combinations of two or more types of silica, differing in the functionality of groups appended to the surface of the silica, may be used to adjust q/m of the toner in 2-component electrophotographic developers. The present invention is using this discovery to adjust the charge-to-mass ratio of the toner particles in a two-component developer. The surface of the toner particles are coated with between 0.75% and 5.0% silica using at least two types of silica particles that differ by the functional groups appended to the surface of the silica particles. The silica particles have average diameters, as measured by field emission scanning electron micrographs, of between 7 nm and 70 nm. Although the silica can be appended with many different functional groups, it is preferable to use silane-based derivatives. Such derivatives include dimethyl-dichloro-silane, hexamethyl-disalazane, silicone oil, trimethoxy-octyl-silane, octamethyl-cyclo-tetra-siloxane, hexadecyl-silane, triethoxy-proply-amino-silane, methyacryl-silane, or the like. Appropriate silicas are commercially available.

It is most advantageous to use this invention with toners having diameters between 3.0 μm and 6.0 μm. The total quantity of silica is determined by factors such as toner flow, transferability, or various image quality metrics such as granularity. However, if the toner particle diameter exceeds approximately 9 μm, the amount of silica present after optimizing those parameters might be insufficient to allow a sufficient number of tribocharging sites to effectively control the charge. Conversely, if the toner particles are too small, for example, less than approximately 2 μm, it might be necessary to use so much silica so as to form large silica agglomerates (greater than 100 nm in diameter). This would limit the number of triboelectrically charging sites on the silica actually available to tribocharge. For most applications, it is only necessary to use two distinct functionally-treated silicas to gain the advantages of the present invention. In some applications, however, such as when it is desired to stabilize the charge of the developer with toner concentration variations or with variations in relative humidity, it may be desired to add additional distinct functionalized silicas. The specific choice of silica varies with the toners and carriers that are to be used in forming the electrophotographic developer.

Toners can be surface treated with two or more functionalized silicas using known methods. Such methods include physically blending the toner particles with the appropriate quantities of the chosen silicas. For small laboratory quantities, household blenders can be used. For large production quantities, high-energy stirring batch mixers such as those available from Thyssen-Henschel Corporation can be used. The advantages of this invention are limited to so-called dry, 2-component developers comprising toner and magnetic carrier particles. No advantage is foreseen for single component dry developers in which charging of the toner particles is accomplished by other means. Similarly, no advantage is seen for liquid based systems in which toner charging is generally accomplished by chemical means.

This invention is also most beneficial when practiced with toners that have a narrow size distribution because wide size distributions tend to broaden the distribution of charge of the toner. Such a broad charge distribution would tend to mask the benefits of this invention. Specifically, it is desirable that the fineness index be between 1.0 and 1.3. Such distributions are commonly obtained by making the toners by chemical means such as evaporative limited coalescence, suspension polymerization, limited coalescence, emulsion polymerization, and the like. The size distribution of toner may be narrowed by classification of the toner after it was made. Ground toners may benefit by this invention if the fineness index is less than 1.3. However, it is typical for most ground and well-classified toners to have fineness indexes between 1.4 and 1.5.

When practicing this invention, the q/m ratio may be determined by various known techniques, for example as described by Maher (IS&T's Tenth International Congress on Advances in Non-Impact Printing Technologies (1994), pp. 156-159). The specific method of determining the q/m ratio is not critical as long as that method can precisely and reproducibly determine the q/m ratio. It is recommended, however, that a single method of measuring the q/m ratio be consistently used, as the values of q/m may vary from one method to another. Toner diameter may be determined using a commercially available device such as the Coulter Multisizer.

### EXAMPLE

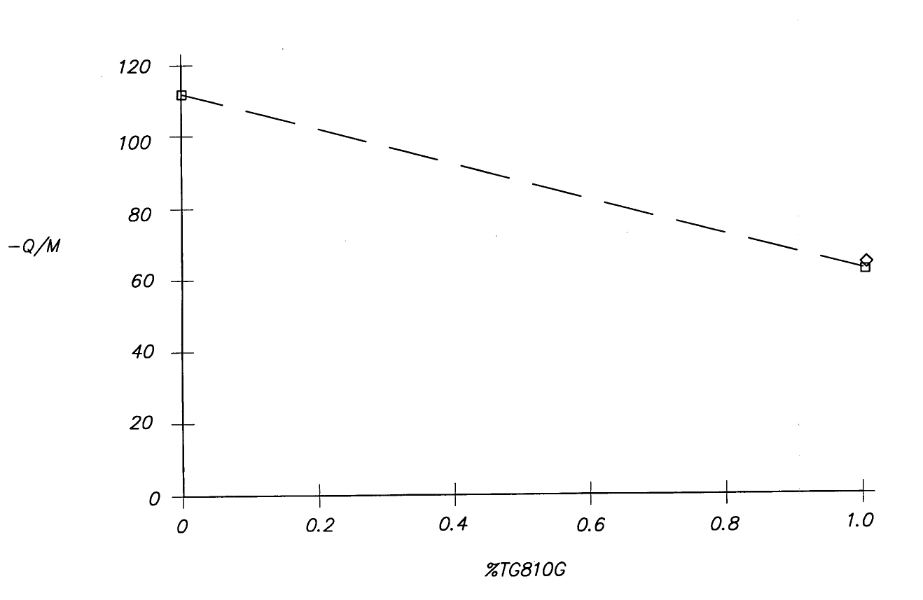

An Evaporative Limited Coalescence process was used to produce a batch of toner with a volume weighted average diameter of 4.2 μm. The toner was surface treated with silica using an overhead stirrer. The total amount of silica was 2.49% by weight. Two different silicas were used, TG810G (surface modification: hexamethyldisalazane) manufactured by Cabot Corp., and R972 (surface modification: dichlorodimethylsilane) manufactured by Degussa AG. Several samples of the toner were surface treated with blends with varying ratios of the two silicas. Developers were made with each surface treated toner sample, by mixing with the same silicone coated ferrite carrier, at a toner concentration of 6% by weight. FIG. 1 is a plot of the charge-to-mass ratio of the toner from each developer sample versus the percent of TG810G in the silica blend surface treatment on the toner. As can be seen from the plot, the charge-to-mass ratio as a function of % TG810G can be fit to a straight line with a slope of about 47 with a correlation coefficient of 0.996. This represents a change of about 85% in q/m in going from 100% R972 with a q/m of about −64 μC/g to a calculated q/m of about −111 μC/g for 100% TG810G.

The invention has been described in detail with particular reference to certain preferred embodiments thereof, but it will be understood that variations and modifications can be effected within the spirit and scope of the invention.

1. A method of adjusting the charge-to-mass ratio of a particulate toner in a two-component developer, said method comprising:
a. forming a mixture of said particulate toner and a predetermined amount of a blend of two or more types of silica particles, each type of said silica particles having a different functional group appended thereto;
b. mechanically agitating said mixture thereby causing said silica particles to become attached to the surfaces of said particulate toner;
c. mixing said particulate toner, having said silica particles attached, with a pre-selected particulate carrier, in a predetermined ratio, to form said developer.

2. The method according to claim 1, wherein said predetermined amount of said blend is in the range from 0.75% to 5.0% by weight.

3. The method according to claim 2, wherein said functional group is a silane based derivative.

4. The method according to claim 3, wherein said functional group is selected from the group consisting of dimethyl-dichloro-silane, hexamethyl-disalazane, silicone oil, trimethoxy-octyl-silane, octamethyl-cyclo-tetra-siloxane, hexadecyl-silane, triethoxy-proply-amino-silane, and methyacryl-silane.

5. The method according to claim 1, wherein said particulate toner has a volume weighted average diameter in the range from about 3.0 μm to about 6.0 μm.

6. The method according to claim 5, wherein said predetermined amount of said blend is in the range from 0.75% to 5.0% by weight.

7. The method according to claim 6, wherein said functional group is a silane based derivative.

8. The method according to claim 7, wherein said functional group is selected from the group consisting of dimethyl-dichloro-silane, hexamethyl-disalazane, silicone oil, trimethoxy-octyl-silane, octamethyl-cyclo-tetra-siloxane, hexadecyl-silane, triethoxy-proply-amino-silane, and methyacryl-silane.

9. The method according to claim 5, wherein said particulate toner has a fineness index in the range from about 1.0 to about 1.3.

10. The method according to claim 9, wherein said predetermined amount of said blend is in the range from 0.75% to 5.0% by weight.

11. The method according to claim 10, wherein said functional group is a silane based derivative.

12. The method according to claim 11, wherein said functional group is selected from the group consisting of dimethyl-dichloro-silane, hexamethyl-disalazane, silicone oil, trimethoxy-octyl-silane, octamethyl-cyclo-tetra-siloxane, hexadecyl-silane, triethoxy-proply-amino-silane, and methyacryl-silane.

13. A tribocharge control additive for a particulate toner in a two-component developer comprising a blended mixture of two or more types of silica particles, each type of said silica particles having a different functional group appended thereto.

14. The tribocharge control additive according to claim 13, wherein said functional group is a silane based derivative.

15. The tribocharge control additive according to claim 14, wherein said functional group is selected from the group consisting of dimethyl-dichloro-silane, hexamethyl-disalazane, silicone oil, trimethoxy-octyl-silane, octamethyl-cyclo-tetra-siloxane, hexadecyl-silane, triethoxy-proply-amino-silane, and methyacryl-silane.

16. A component of a two-component developer, comprising:
a particulate toner;
a blended mixture of two or more types of silica particles, adhered to the surfaces of said particulate toner, each type of said silica particles having a different functional group appended thereto; and
magnetic carrier particles.

17. The component according to claim 16, wherein said functional group is a silane based derivative.

18. The component according to claim 17, wherein said functional group is selected from the group consisting of dimethyl-dichloro-silane, hexamethyl-disalazane, silicone oil, trimethoxy-octyl-silane, octamethyl-cyclo-tetra-siloxane, hexadecyl-silane, triethoxy-proply-amino-silane, and methyacryl-silane.
